(19) United States
(12) Patent Application Publication
(10) Pub. No.: US 2011/0140495 A1
(43) Pub. Date: Jun. 16, 2011

(54) Head and Neck Support Apparatus and Method

(76) Inventor: Khashayar Nourishad, Thousand Oaks, CA (US)

(21) Appl. No.: 12/959,191

(22) Filed: Dec. 2, 2010

Related U.S. Application Data
(60) Provisional application No. 61/283,855, filed on Dec. 10, 2009.

(51) Int. Cl. B60N 2/48

(52) U.S. Cl. 297/397

(57) ABSTRACT

Some embodiments of the invention provide a head and neck support apparatus for a person in a seat. The apparatus includes a body with a recessed lunar area and side portions on either side of the lunar area. The apparatus also includes one or more extensions on either side of the body, and an attachment portion coupled to the extensions. The attachment portion secures at least a portion of the apparatus against the person's chest when the apparatus is removably coupled to the seat or positioned around the seat.

### RELATED APPLICATIONS

This application claims priority under 35 U.S.C. §119 to U.S. Provisional Patent Application No. 61/283,855 filed on Dec. 10, 2009, the entire contents of which is incorporated herein by reference.

### BACKGROUND

Standard car seats designed for children, such as booster seats or child safety seats, fail to properly support a child's neck and head from falling forward while the child is asleep in the car seat. Conventional travel pillows can wrap around the back and sides of a child's head, but only provide lateral neck and head support. Wrap-around pillows can wrap around a child's neck to provide front support for a child's head as well as lateral support. However, because these pillows wrap around the child's neck, they can be hazardous to the child's safety in the event of sudden stopping or a minor car accident.

### SUMMARY

Some embodiments of the invention provide a head and neck support apparatus for a person in a seat. The apparatus may include a body with a recessed lunar area that provides substantial chin clearance for the person and side portions on either side of the lunar area. The side portions provide substantial head and neck support for the person. In some embodiments, the apparatus also includes at least one extension on a side of the body and an attachment portion coupled to the extension. The attachment portion secures at least a portion of the apparatus against the person's chest when the apparatus is removably coupled to the seat or positioned around the seat.

Some embodiments provide a method for supporting a child's head and neck while sitting in a seat. The method may include providing a support apparatus including a body with a recessed lunar area and side portions on either side of the lunar area, at least one extension on a side of the body, and an attachment portion coupled to the extensions. The method may also include positioning the support apparatus at a desired position across the child's chest so that the recessed lunar area provides chin clearance and the side portions provide head and neck support, and maintaining the support apparatus at the desired position using the attachment portion.

### DESCRIPTION OF THE DRAWINGS

FIG. 1 is a front perspective view of a head and neck support apparatus according to one embodiment of the invention installed on a standard car seat.

FIG. 2 is a front view of the head and neck support apparatus of FIG. 1.

FIG. 3 is a back view of the head and neck support apparatus of FIG. 1.

FIG. 4 is a back perspective view of the head and neck support apparatus of FIG. 1 on a standard car seat.

FIG. 5 is a front perspective view of the head and neck support apparatus of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

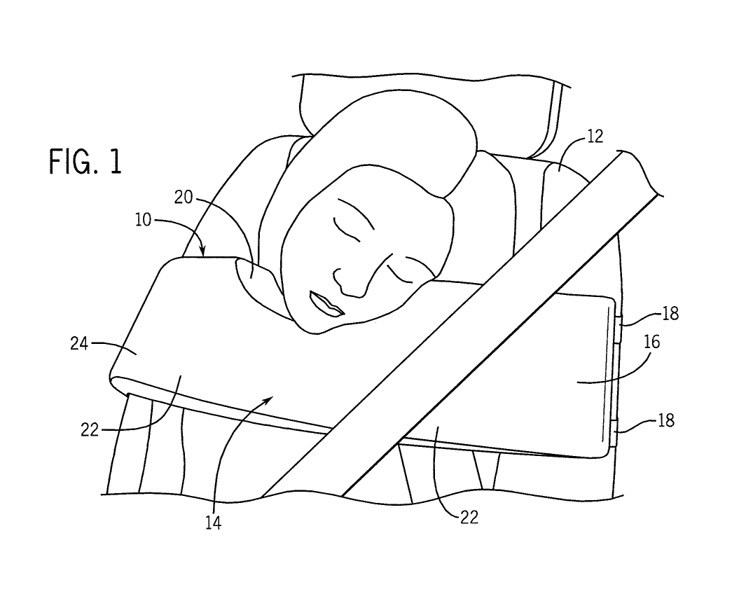

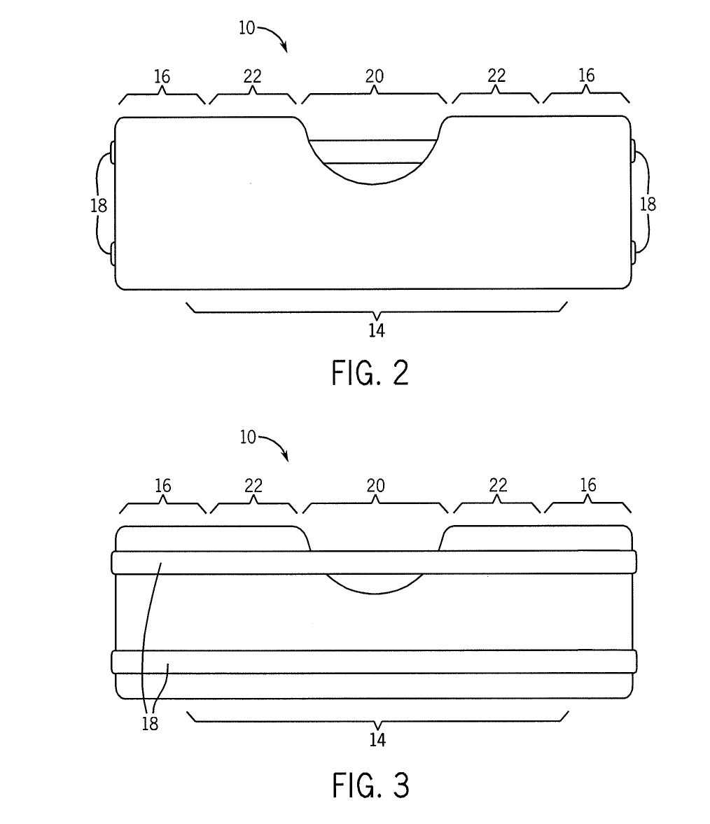

FIG. 1 illustrates a head and neck support apparatus 10 according to one embodiment of the invention. As shown in FIG. 1, the apparatus 10 can be used to support a child's neck or head while they are sitting in a seat 12, such as such as a safety seat, car seat, airplane seat, wheelchair seat, stroller seat etc. The apparatus 10 can help avoid forward and down movements resulting from driver braking or uncontrolled neck support due to the child being asleep. The apparatus 10 can be a stand-alone item or can be an attachment to the seat 12. As shown in FIGS. 2 and 3, the apparatus 10 can include a body 14, one or more extensions 16, and an attachment portion 18. In some embodiments, the apparatus 10 can comprise a cushioning material, such as a high density foam or other suitable supportive material.

In some embodiments, the body 14 can include a lunar area 20 and side portions 22. The lunar area 20 can be a recessed portion or indentation of the body 14. The lunar area 20 can be located near the center of the body 14 to support the child's chest and provide clearance for the child's chin. In some embodiments, the lunar area 20 can have a half-moon or crescent shape. The side portions 22 to the left and to the right of the lunar area 20 can have a consistent height, or a descending or ascending height along their lengths. The side portions 22 can be positioned high enough to provide substantial support for the child's head and neck (e.g., at mid-cheek level), while the lunar area 20 can provide enough clearance for the child's chin to allow a full or desired range of movement for the child's head. As a result, the apparatus 10 can provide lateral support for a child's head as well as front support.

In some embodiments, the body 14 can be between about 12 inches and about 14 inches long. The length of the body 14 can be dependent on the intended use of the apparatus 10. For example, smaller children can require a shorter apparatus 10, while bigger children can require a longer apparatus 10. The lunar area 20 can have a length between about 5 inches and about 7 inches, depending upon the size of the child with whom the apparatus 10 is intended to be used. The side portions 22 can each be about 3.5 inches long. In one embodiment, the apparatus 10 can be used for a small child and the body 14 can be about 12 inches long with a 5-inch long lunar area 20.

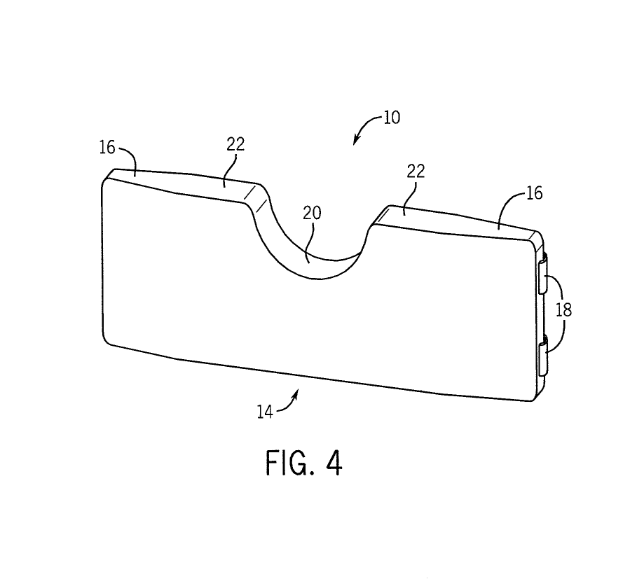

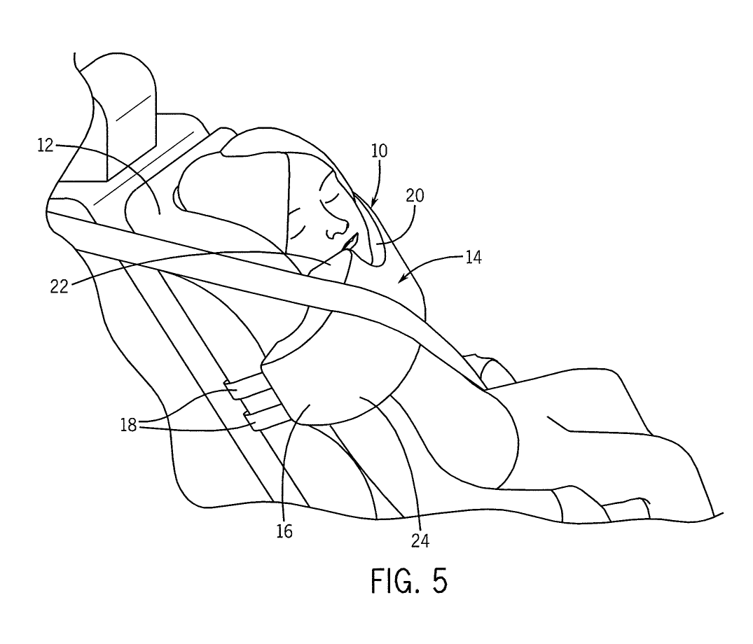

In some embodiments, a thickness or depth of the body 14 can be about 2 inches. This depth can be consistent through the side portions 22 as well as the lunar area 20, as shown in FIG. 4. A maximum height of the body 14 can be about 6 inches, to avoid pressing against the sternum of the child when deployed. In addition, the apparatus 10 can include the extensions 16 to the left and the right of the side portions 22. In one embodiment, the extensions 16 can each be about 5 inches in length, about 6-8 inches in height, and about 1 inch in thickness. As a result, the total length of the apparatus 10, including the body 14 and the extensions 16 can be about 22 inches to about 24 inches. In one embodiment, the body 14 and the extensions 16 are one integral piece (i.e., constructed of a single piece of material). In addition, in some embodiments, the dimensions can be larger for the apparatus 10 to accommodate an adult rather than a child.

In one embodiment, the body 14 and the extensions 16 can be encased in a soft fabric cover 24. The cover 24 can be permanent or changeable. For example, if the cover 24 is changeable, the cover 24 can include a zipper (not shown) to allow for removal (e.g., for washing). In other embodiments, the cover 24 can include Velcro®, buttons, or other fasteners for removal.

As shown in FIGS. 1 and 5, the apparatus 10 can be positioned around, or removably coupled to, the seat 12 via the attachment portion 18. The attachment portion 18 can be positioned over or around the seat 12 so that the apparatus 10 does not interfere with the child's seatbelt or compromise any safety features of the seat 12. For example, in some embodiments, the apparatus 10 lies flat across the child's chest to keep the child upright in the seat 12 but not apply pressure against the child's neck in the event of an accident, collision, or fast breaking. Conventional wrap-around pillows hold tight across the child's neck to provide substantial support for the child's head, essentially causing the child to choke in such accident situations. Also, the attachment portion 18 can be positioned so that the apparatus 10 can be easily removed by the child or another person, making removal of the child from the car seat 12 substantially no different than if the apparatus 10 were not being used.

In one embodiment, the attachment portion 18 can include one or more elastic straps coupled to the extensions 16, as shown in FIG. 3. The elastic straps can have a substantially parallel orientation, as shown in FIG. 3, or a “crisscross” orientation (not shown). The elastic straps can be between about 22 inches to about 24 inches long and about 1 inch in width. The elastic straps can lay flat against the back of the seat 12 (e.g., not stretched or sagging) and can accommodate different sizes of children or adults, different sizes of seats, and additional side extensions on some seats. The elasticity can allow easy removal of the apparatus 10 by the child simply pulling the body forward and up above their head. In addition, dual elastic straps in some embodiments can help locate the body 14 correctly with different neck positions.

In another embodiment, the attachment portion 18 can include a hook and loop fastener mechanism, such as Velcro®, positioned at each of the extensions 16. In yet another embodiment, the attachment portion 18 can include one or more buttons and mating button holes, where the buttons are attached to the extensions 16, and the mating button holes are secured to the seat 12, either directly or indirectly, at about the same height as the child's neck, or vice versa. Other attachment mechanisms can also be readily used in or on the attachment portion 18.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A head and neck support apparatus for a person in a seat, the apparatus comprising:
a body including a recessed lunar area that provides chin clearance for the person, and side portions on either side of the lunar area, the side portions providing head and neck support for the person;
at least one extension on a side of the body; and
an attachment portion coupled to the at least one extension and securing at least a portion of the apparatus against the person's chest when the apparatus is one of removably coupled to the seat and positioned around the seat.

2. The apparatus of claim 1 wherein the recessed lunar area is positioned centrally along a length of the body.

3. The apparatus of claim 1 wherein the side portions can be positioned at about mid-cheek level of the person when the apparatus is one of removably coupled to the seat and positioned around the seat.

4. The apparatus of claim 1 wherein the attachment portion includes at least one elastic strap.

5. The apparatus of claim 1 wherein the attachment portion is a hook and loop fastener mechanism.

6. The apparatus of claim 1 and further comprising a cover encasing the body and the at least one extension.

7. The apparatus of claim 1 wherein the body and the at least one extension are constructed from a single piece of material.

8. The apparatus of claim 1 wherein the body and the at least one extension comprise a high density foam material.

9. The apparatus of claim 1 wherein the body is between about 12 inches and about 14 inches long.

10. The apparatus of claim 1 wherein the lunar area is between about 5 inches and about 7 inches long.

11. The apparatus of claim 1 wherein the side portions are each about 3.5 inches long.

12. The apparatus of claim 1 wherein the body is about 2 inches thick.

13. The apparatus of claim 1 wherein the extensions are each about 5 inches long.

14. The apparatus of claim 1 wherein the extensions are each about 1 inch thick.

15. The apparatus of claim 1 wherein the extensions are each between about 6 inches and about 8 inches in height.

16. A head and neck support apparatus for use with a seat, the apparatus comprising:
a body including a recessed lunar area;
extensions on either side of the body; and
an attachment portion removably coupling the extensions to the seat so that the body and the extensions are positioned across a front portion of the seat.

17. The apparatus of claim 16 and further comprising a cover encasing the body and the extensions.

18. A method for supporting a child's head and neck while sitting in a seat, the method comprising:
providing a support apparatus including
a body with a recessed lunar area and side portions on either side of the lunar area,
at least one extension on a side of the body, and
an attachment portion coupled to the extensions;
positioning the support apparatus at a desired position across the child's chest so that the recessed lunar area provides chin clearance and the side portions provide head and neck support; and
maintaining the support apparatus at the desired position using the attachment portion.

19. The method of claim 18, wherein maintaining the support apparatus at the desired position includes positioning the attachment portion around the seat.

20. The method of claim 18, wherein maintaining the support apparatus at the desired position includes coupling the attachment portion to the seat.
